(19) United States
(12) Patent Application Publication
(10) Pub. No.: US 2014/0164561 A1
(43) Pub. Date: Jun. 12, 2014

(54) COMPRESSED PACKAGE UPLOAD MANAGEMENT SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: ZHI-QUAN CHAI, Shenzhen (CN); DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/067,024

(22) Filed: Oct. 30, 2013

(30) Foreign Application Priority Data
Dec. 12, 2012 (CN) 2012105336575

(51) Int. Cl. H04L 29/08

(52) U.S. Cl. CPC H04L 67/10
USPC 709/217

(57) ABSTRACT

A client divides a compressed package into two or more data blocks. The client deletes the repetitive data blocks from the client, and sets a storage space in a server for storing each data block from the client. The client uploads each data block from the client into the storage space corresponding to the data block.

### BACKGROUND

1. Technical Field

The embodiments of the present disclosure relate to management technology, and particularly to a compressed package upload management system and method.

2. Description of Related Art

A data center is a facility which houses a large number of computers and stores huge amounts of data. By using cloud computing, the files are uploaded into a data center. However, at present, the data center may store a plurality of repetitive files, which wastes a lot of storage spaces. For example, the data center may repetitively store the same file five times. Furthermore, different files stored in the data center may share one or more same portions, which also waste a lot of storage spaces. Therefore, there is room for improvement in the art.

### BRIEF DESCRIPTION OF THE DRAWINGS

FIG. 1 is a block view of one embodiment of a server including a compressed package upload management system.

FIG. 2 is a block diagram of one embodiment of function modules of the compressed package upload management system in FIG. 1.

FIG. 3 is a flowchart of one embodiment of a compressed package upload management method.

FIG. 4 illustrates one embodiment of dividing a compressed package into two or more data blocks.

FIG. 5 is a flowchart of one embodiment of downloading an encrypted compressed package from a server.

FIG. 6 is a flowchart of one embodiment of downloading an unencrypted compressed package from the server.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

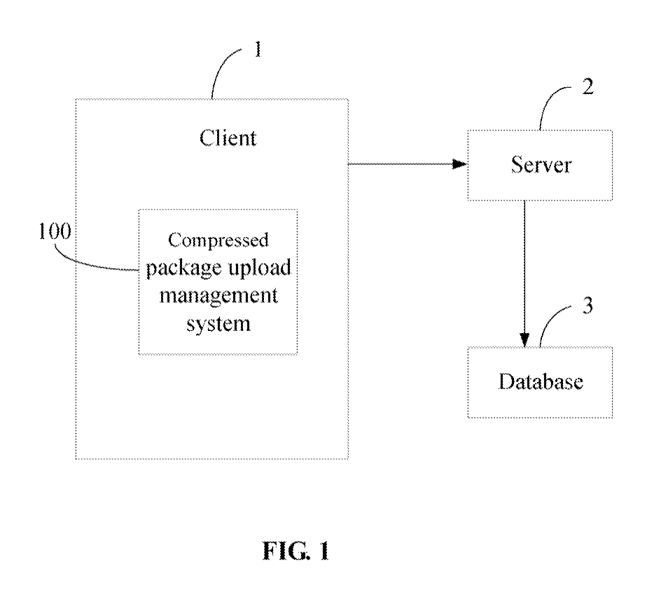

FIG. 1 is a block diagram of one embodiment of a client 1. In this embodiment, the client 1 includes a compressed package upload management system 100. The client 1 connects to a server 2 via a network (e.g., the Internet or a local area network). The client 1 may provide a user interface, which is displayed on a display device of the client 1, for a user to access the server 2 and control one or more operations of the server 2. The user may input an ID and a password using an input device (e.g., a keyboard) into the user interface to access the server 2. The client 1 may be, but is not limited to, a mobile phone, a tablet computer, a personal computer or other data-processing apparatus. The server 2 connects to a database 3 using a data connectivity, such as open database connectivity (ODBC) or JAVA database connectivity (JDBC), for example. Additionally, the server 2 may be, but not limited to, one server of a data center.

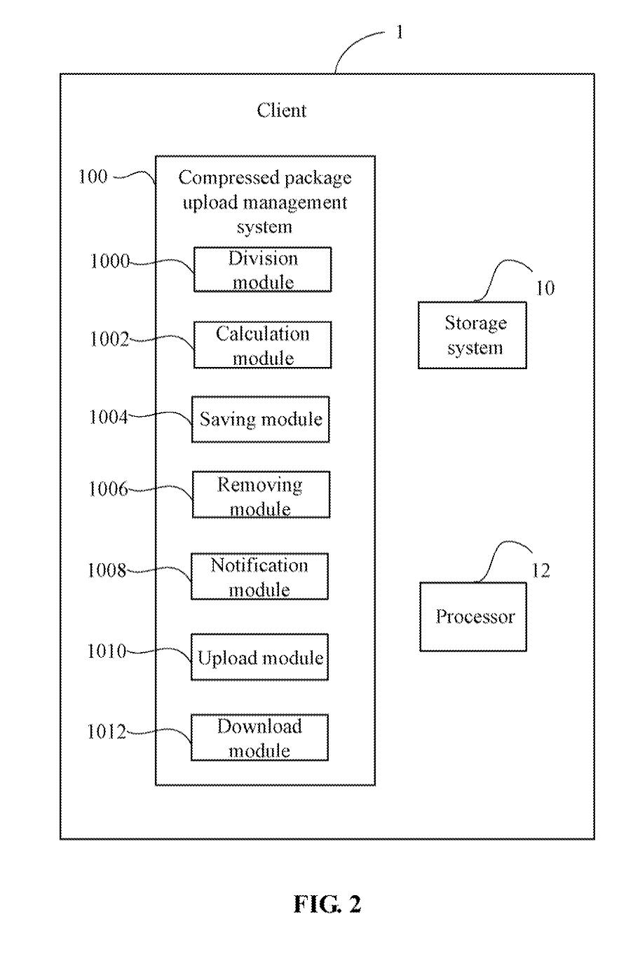

FIG. 2 is a block diagram of one embodiment of the compressed package upload management system 100 included in the client 1 of FIG. 1. The compressed package upload management system 100 processes a compressed package and uploads the compressed package into the server 2. In one embodiment, the client 1 further includes a storage system 10 and at least one processor 12. The compressed package upload management system 100 includes a dividing module 1000, a calculation module 1002, a saving module 1004, a removing module 1006, a notification module 1008, an upload module 1010, and a download module 1012. The modules 1000-1012 may include computerized code in the form of one or more programs that are stored in the storage system 10. The computerized code includes instructions that are executed by the at least one processor 12 to provide functions for the modules 1000-1012. The storage system 10 may be a memory, such as an EPROM memory chip, hard disk drive (HDD), or flash memory stick. The files are also stored in the storage system 10.

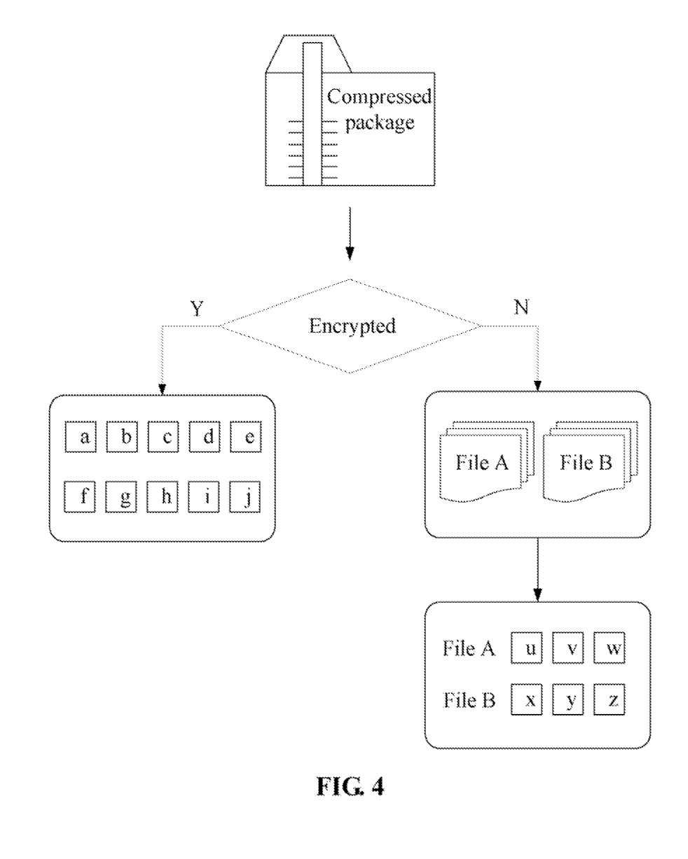

The dividing module 1000 divides the compressed package into two or more data blocks. In one embodiment, the compressed package may include multiple data files which are packed and compressed into a single file for easier portability and storage via a file compressed packager (e.g., WINRAR tool). In other words, the compressed package is a compressed file in ZIP or RAR file format. Additionally, the compressed package may be encrypted using an encryption algorithm (e.g., international data encryption algorithm, or describes symmetric and asymmetric algorithm). As shown in FIG. 4, if the compressed package is encrypted, the dividing module 1000 directly divides the compressed package into two or more data blocks. For example, the dividing module 1000 divides the compressed package into data blocks, namely a data block a, a data block b, a data block c, data block d, a data block e, a data block f, a data block g, a data block h, a data block i, and data block j. If the compressed package is unencrypted, the compressed package is decompressed into one or more files, and the dividing module 1000 divides each file into two or more data blocks. For example, the compressed package is decompressed into a file A and a file B, and the dividing module 1000 divides the file A into three data blocks, namely a data block u, a data block v, and a data block w, and dividing module 1000 divides the file B into three data blocks, namely a data block x, a data block y, and a data block z. Furthermore, the compressed package corresponds to a hash value.

The calculation module 1002 calculates a hash value of each data block. In one embodiment, the calculation module 1002 invokes a hash function to calculate the hash value of each data block.

The saving module 1004 saves encrypted information of the compressed package, the hash value of the compressed package, the hash value of each data block, and a sequence number of each data block into a hash list stored in a database 3. The hash list corresponds to the compressed package.

The removing module 1006 obtains repetitive data blocks in the client 1 according to the hash value of each data block and deletes the repetitive data blocks from the client 1, and sets a storage space in the server 2 for storing each data block from the client 1. In one embodiment, if the data block stored in the client is the same as the data block stored in the server 2, the data block stored in the client 1 is determined as a repetitive data block. The removing module 1006 obtains the repetitive data blocks using a file distributor. The file distributer searches the database 3, and determines if the database 3 contains two or more hash values which are the same. Each hash value corresponds to one data block, when the database 3 includes two or more hash values which are the same, the client 1 includes one data block which is the same as the data block stored in the server 2. If the database 3 includes two or more hash values which are the same, the removing module 1006 obtains the repetitive data block and deletes the repetitive data block from the client 1. For example, if the database 3 includes two hash values which are the same, the removing module 1006 deletes the repetitive data block corresponding to the two hash values from the client 1. Additionally, each data block corresponds to a pointer that points to the storage space. In other words, a user uses the pointer to find the storage space. The storage space may store one or more data blocks in the server 2. Furthermore, even the repetitive data blocks are deleted from the client 1, however, each repetitive data block is also assigned to one pointer, and the pointer corresponding to the repetitive data block is the same as the pointer corresponding to the data block in the server 2, wherein the repetitive data block is the same as the data block in the server 2.

The notification module 1008 notifies a user about information of the repetitive data blocks. The information of the repetitive data blocks includes pointers of the repetitive data blocks.

The uploading module 1010 uploads each data block from the client 1 into the storage space corresponding to the data block. In one embodiment, when the server 2 receives the data blocks from the client 1, the server 2 also calculates the hash value of each data block, and verifies if the hash value of each data block exists in the hash list. If the hash value of each data block exists in the hash list, the server 2 saves each data block into the storage space corresponding to the data block. If one hash value of the data block does not exist in the hash list, the server 2 rejects the client 1 for uploading the data blocks and notifies the client 1 that the data block is rejected for uploading.

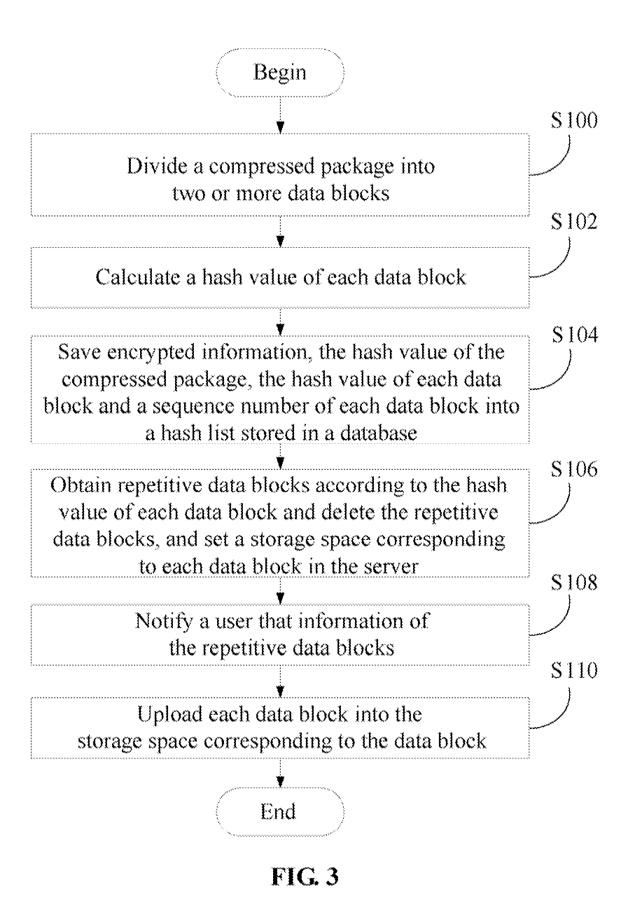

FIG. 3 is a flowchart of one embodiment of a compressed package upload management method. Depending on the embodiment, additional steps may be added, others deleted, and the ordering of the steps may be changed.

In step S100, the dividing module 1000 divides the compressed package into two or more data blocks. In one embodiment, the compressed package is encrypted or unencrypted. For example, as shown in FIG. 4, the dividing module 1000 divides the compressed package into data blocks, namely data block a, data block b, data block c, data block d, data block e, data block f, data block g, data block h, data block i and data block j. If the compressed package is encrypted, the compressed package is directly divided into two or more data blocks. For example, as shown in FIG. 4, the compressed package is decompressed into file A and file B, and the dividing module 1000 divides the file A into three data blocks, namely data block u, data block v and data block w, and dividing module 1000 divides the file B into three data blocks, namely data block x, data block y, and data block. Furthermore, the compressed package corresponds to a hash value. Each data block may include a storage capacity predetermined by a user, such as 16 KB, 32 KB, 64 KB, 128 KB, or 256 KB. For example, if storage capacity is predetermined as 32 KB, the compressed package is divided into a plurality of data blocks, and each data block is 32 KB.

In step S102, the calculation module 1002 calculates a hash value of each data block. As mentioned above, the calculation module 1002 invokes a hash function to calculate the hash value of each data block.

In step S104, the saving module 1004 saves encrypted information of the compressed package, the hash value of the compressed package, the hash value of each data block and a sequence number of each data block into a hash list stored in a database 3. The hash list corresponds to the compressed package. The encrypted information of the compressed package indicates whether the compressed package is encrypted or not. In detail, when the compressed package is encrypted, the encrypted information of the compressed package may be a letter, such as “Y.” When the compressed package is unencrypted, the encrypted information of the compressed package may be another letter, such as “N.”

In step S106, the removing module 1006 obtains repetitive data blocks in the client 1 according to the hash value of each data block and deletes the repetitive data blocks from the client 1, and sets a storage space in the server 2 for storing each data block from the client 1. In one embodiment, the data block stored in the client 1 is determined as the repetitive data block upon the condition that the data block stored in the client is the same as the data block stored in the server 2. Due to each hash value corresponding to one data block, if the database 3 includes two or more hash values which are the same, the client 1 includes one data block which is the same as the data block stored in the server 2, the removing module 1006 obtains the repetitive data block and deletes the repetitive data block from the client 1. For example, if the database 3 includes two hash values which are the same, the removing module 1006 deletes the repetitive data block corresponding to the two hash values from the client 1. Additionally, each data block corresponds to a pointer that points to the storage space. The storage space may store one or more data blocks in the server 2. Furthermore, even the repetitive data blocks are deleted in the client 1, however, each repetitive data block is also assigned to one pointer, and the pointer corresponding to the repetitive data block is the same as the pointer corresponding to the data block in the server 2, wherein the repetitive data block is the same as the data block in the server 2.

In step S108, the notification module 1008 notifies a user about information of the repetitive data blocks. The information of the repetitive data blocks includes pointers of the repetitive data blocks.

In step S110, the uploading module 1010 uploads each data block from the client 1 into the storage space corresponding to the data block. In one embodiment, when the server 2 receives the data blocks from the client 1, the server 2 also calculates the hash value of each data block, and verifies if the calculated hash value of each data block exists in the hash list stored in the database 3. If the calculated hash value of each data block exists in the hash list, the server 2 saves each data block into the storage space corresponding to the data block. If one hash value of the data block does not exist in the hash list, the server 2 rejects the client 1 for uploading the data blocks and notifies the client 1 that the data block is rejected for uploading the data block.

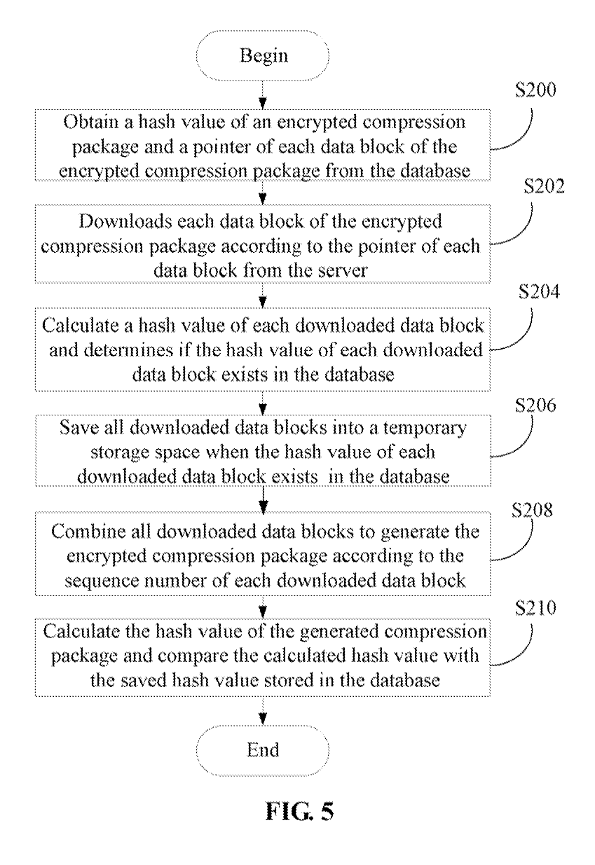

FIG. 5 is a flowchart of one embodiment of downloading an encrypted compressed package from a server.

In step S200, the download module 1012 obtains a hash value of an encrypted compressed package and a pointer of each data block of the encrypted compressed package from the database 3.

In step S202, the download module 1012 downloads each data block of the encrypted compressed package according to the pointer of each data block from the server 2.

In step S204, the download module 1012 calculates a hash value of each downloaded data block and determines if the hash value of each downloaded data block exists in the hash list stored in the database 3.

In step S206, the download module 1012 saves all downloaded data blocks into a temporary storage space of the client 1 when the hash value of each downloaded data block exists in the database 3. The temporary storage space of the client 1 may be, but is not limited to, a random access memory (RAM).

In step S208, the download module 1012 combines all downloaded data blocks to generate the encrypted compressed package in the temporary storage space according to the sequence number of each downloaded data block.

In step S210, the download module 1012 calculates the hash value of the generated compressed package and determines the calculated hash value of the generated compressed package exists in the hash list stored in the database 3. If the calculated hash value of the generated compressed package exists in the hash list, the download module 1012 displays success information (e.g., display “SUCCESS”) in a display device of the client 1. If the calculated hash value of the generated compressed package does not exists in the hash list, the download module 1012 displays fail information (e.g., display “FAIL”) in the display device of the client 1.

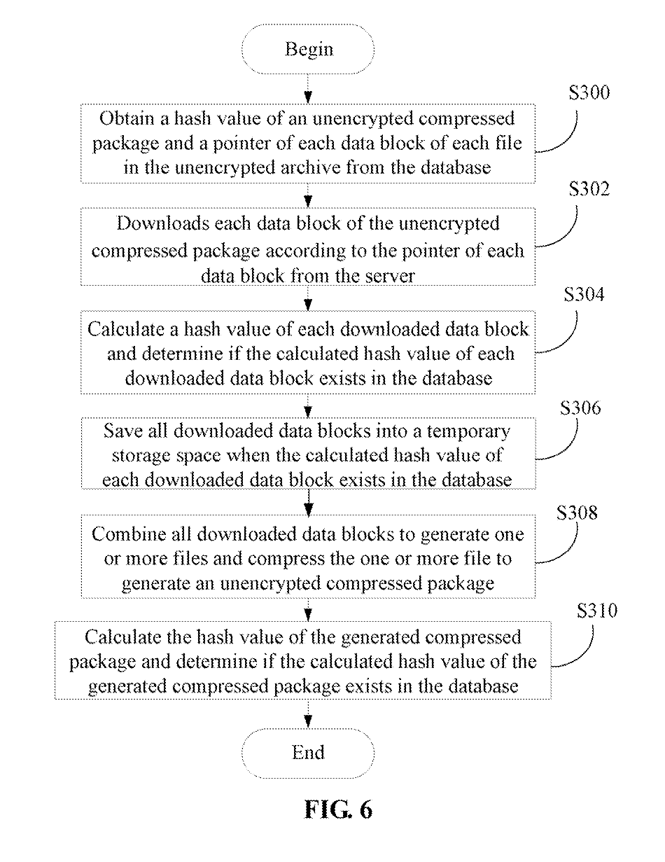

FIG. 6 is a flowchart of one embodiment of downloading an unencrypted compressed package from the server.

In step S300, the download module 1012 obtains a hash value of an unencrypted compressed package and a pointer of each data block of each file in the unencrypted compressed package from the database 3.

In step S302, the download module 1012 downloads each data block of the unencrypted compressed package according to the pointer of each data block from the server 2.

In step S304, the download module 1012 calculates a hash value of each downloaded data block and determines if the calculated hash value of each downloaded data block exists in the hash list stored in the database 3.

In step S306, the download module 1012 saves all downloaded data blocks into a temporary storage space of the client 1 when the calculated hash value of each downloaded data block exists in the database 3.

In step S308, the download module 1012 combines all downloaded data blocks to generate one or more files and compresses the one or more file to generate an unencrypted compressed package.

In step S310, the download module 1012 calculates the hash value of the generated compressed package and determine if the calculated hash value of the generated compressed package exists in the database 3. If the calculated hash value of the generated compressed package exists in the hash list, the download module 1012 displays success information (e.g., display “SUCCESS”) in a display device of the client 1. If the calculated hash value of the generated compressed package does not exists in the hash list, the download module 1012 displays fail information (e.g., display “FAIL”) in the display device of the client 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A client in electronic communication with a server, comprising:
at least one processor; and
a storage system that stores one or more programs, when executed by the at least one processor, cause the at least one processor to perform a compressed package upload management method, the method comprising:
dividing a compressed package into two or more data blocks;
calculating a hash value of each data block and a hash value of the compressed package;
saving encrypted information of the compressed package, the hash value of the compressed package, the hash value of each data block and a sequence number of each data block into a hash list stored in a database connected to the server;
obtaining repetitive data blocks in the client according to the hash value of each data block, deleting the repetitive data blocks from the client, and setting a storage space in the server for storing each data block, wherein each data block corresponds to a pointer which points to the storage space;
notifying a user about information of the repetitive data blocks; and
uploading each data block from the client into the storage space corresponding to the data block according to the pointer corresponding to the data block.

2. The client of claim 1, wherein the compressed package comprises multiple data files which are packed and compressed into a single file, and the compressed package is an encrypted compressed package or an unencrypted compressed package.

3. The client of claim 2, wherein the encrypted compressed package is divided into two or more data blocks, and the unencrypted compressed package is decompressed into one or more files and each file is divided into two or more data blocks.

4. The client of claim 1, wherein the data block stored in the client is determined as a repetitive data block upon the condition that the data block stored in the client is the same as the data block stored in the server.

5. The client of claim 2, wherein a method of downloading the encrypted compressed package from the server comprises:
obtaining a hash value of the encrypted compressed package and the pointer of each data block of the encrypted compressed package from the database;
downloading each data block of the encrypted compressed package according to the pointer of each data block from the server;
calculating the hash value of each downloaded data block and determining if the hash value of each downloaded data block exists in the hash list stored in the database;
saving all downloaded data blocks into a temporary storage space of the client when the hash value of each downloaded data block exists in the hash list stored in the database;
combining all downloaded data blocks to generate the encrypted compressed package in the temporary storage space according to the sequence number of each downloaded data block; and
calculating the hash value of the generated compressed package and determining the calculated hash value of the generated compressed package exists in the hash list stored in the database.

6. The client of claim 2, wherein a method of downloading the unencrypted compressed package from the server comprises:
downloading each data block of the unencrypted compressed package according to the pointer of each data block from the server;
calculating a hash value of each downloaded data block and determining if the calculated hash value of each downloaded data block exists in the hash list stored in the database;
saving all downloaded data blocks into a temporary storage space of the client when the calculated hash value of each downloaded data block exists in the database;
combining all downloaded data blocks to generate one or more files and compressing the one or more file to generate an unencrypted compressed package; and
calculating the hash value of the generated compressed package and determining if the calculated hash value of the generated compressed package exists in the database.

7. A compressed package upload management method implemented by a client, the client in electronic communication with a server, the method comprising:
dividing a compressed package into two or more data blocks;
calculating a hash value of each data block and a hash value of the compressed package;
saving encrypted information of the compressed package, the hash value of the compressed package, the hash value of each data block and a sequence number of each data block into a hash list stored in a database connected to the server;
obtaining repetitive data blocks in the client according to the hash value of each data block, deleting the repetitive data blocks from the client, and setting a storage space in the server for storing each data block, wherein each data block corresponds to a pointer which points to the storage space;
notifying a user about information of the repetitive data blocks; and
uploading each data block from the client into the storage space corresponding to the data block according to the pointer corresponding to the data block.

8. The method of claim 7, wherein the compressed package comprises multiple data files which are packed and compressed into a single file, and the compressed package is an encrypted compressed package or an unencrypted compressed package.

9. The method of claim 8, wherein the encrypted compressed package is divided into two or more data blocks, and the unencrypted compressed package is decompressed into one or more files and each file is divided into two or more data blocks.

10. The method of claim 7, wherein the data block stored in the client is determined as a repetitive data block upon the condition that the data block stored in the client is the same as the data block stored in the server.

11. The method of claim 8, wherein a method of downloading the encrypted compressed package from the server comprises:
obtaining a hash value of the encrypted compressed package and a pointer of each data block of the encrypted compressed package from the database;
downloading each data block of the encrypted compressed package according to the pointer of each data block from the server;
calculating the hash value of each downloaded data block and determining if the hash value of each downloaded data block exists in the hash list stored in the database;
saving all downloaded data blocks into a temporary storage space of the client when the hash value of each downloaded data block exists in the hash list stored in the database;
combining all downloaded data blocks to generate the encrypted compressed package in the temporary storage space according to the sequence number of each downloaded data block; and
calculating the hash value of the generated compressed package and determining the calculated hash value of the generated compressed package exists in the hash list stored in the database.

12. The method of claim 8, wherein a method of downloading the unencrypted compressed package from the server comprises:
downloading each data block of the unencrypted compressed package according to the pointer of each data block from the server;
calculating a hash value of each downloaded data block and determining if the calculated hash value of each downloaded data block exists in the hash list stored in the database;
saving all downloaded data blocks into a temporary storage space of the client when the calculated hash value of each downloaded data block exists in the database;
combining all downloaded data blocks to generate one or more files and compressing the one or more file to generate an unencrypted compressed package; and
calculating the hash value of the generated compressed package and determining if the calculated hash value of the generated compressed package exists in the database.

13. A non-transitory computer-readable medium having stored thereon instructions that, when executed by a client, the client in electronic communication with a server, causing the client to perform a compressed package upload management method, the method comprising:
dividing a compressed package into two or more data blocks;
calculating a hash value of each data block and a hash value of the compressed package;
saving encrypted information of the compressed package, the hash value of the compressed package, the hash value of each data block and a sequence number of each data block into a hash list stored in a database connected to the server;
obtaining repetitive data blocks in the client according to the hash value of each data block, deleting the repetitive data blocks from the client, and setting a storage space in the server for storing each data block, wherein each data block corresponds to a pointer which points to the storage space;
notifying a user about information of the repetitive data blocks; and
uploading each data block from the client into the storage space corresponding to the data block according to the pointer corresponding to the data block.

14. The non-transitory computer-readable medium of claim 13, wherein the compressed package comprises multiple data files which are packed and compressed into a single file, and the compressed package is an encrypted compressed package or an unencrypted compressed package.

15. The non-transitory computer-readable medium of claim 14, wherein the encrypted compressed package is divided into two or more data blocks, and the unencrypted compressed package is decompressed into one or more files and each file is divided into two or more data blocks.

16. The non-transitory computer-readable medium of claim 13, wherein the data block stored in the client is determined as a repetitive data block upon the condition that the data block stored in the client is the same as the data block stored in the server.

17. The non-transitory computer-readable medium of claim 14, wherein a method of downloading the encrypted compressed package from the server comprises:
obtaining a hash value of an encrypted compressed package and a pointer of each data block of the encrypted compressed package from the database;
downloading each data block of the encrypted compressed package according to the pointer of each data block from the server;
calculating a hash value of each downloaded data block and determining if the hash value of each downloaded data block exists in the hash list stored in the database;
saving all downloaded data blocks into a temporary storage space of the client when the hash value of each downloaded data block exists in the database;
combining all downloaded data blocks to generate the encrypted compressed package in the temporary storage space according to the sequence number of each downloaded data block; and
calculating the hash value of the generated compressed package and determining the calculated hash value of the generated compressed package exists in the hash list stored in the database.

18. The non-transitory computer-readable medium of claim 14, wherein a method of downloading the unencrypted compressed package from the server comprises:
downloading each data block of the unencrypted compressed package according to the pointer of each data block from the server;
calculating a hash value of each downloaded data block and determining if the calculated hash value of each downloaded data block exists in the hash list stored in the database;
saving all downloaded data blocks into a temporary storage space of the client when the calculated hash value of each downloaded data block exists in the database;
combining all downloaded data blocks to generate one or more files and compressing the one or more file to generate an unencrypted compressed package; and calculating the hash value of the generated compressed package and determining if the calculated hash value of the generated compressed package exists in the database.
